(19) United States
(12) Patent Application Publication
(10) Pub. No.: US 2015/0020644 A1
(43) Pub. Date: Jan. 22, 2015

(54) SCREWLESS KNOB ASSEMBLY FOR TOYS

(71) Applicant: KidKraft, LP, Dallas, TX (US)

(72) Inventors: Daniel Lester Lipschitz, Dallas, TX (US); Wynand DuToit, Dallas, TX (US)

(73) Assignee: KidKraft, LP, Dallas, TX (US)

(21) Appl. No.: 14/219,899

(22) Filed: Mar. 19, 2014

Related U.S. Application Data
(60) Provisional application No. 61/803,392, filed on Mar. 19, 2013.

(51) Int. Cl. G05G 1/10

(52) U.S. Cl. CPC G05G 1/10
USPC 74/543; 29/428

(57) ABSTRACT

A screwless knob assembly includes a knob member and a knob backcover member. The knob member includes a handle and a shaft. The shaft is disposed opposite the handle and is configured to communicate through an aperture of a backing board. A portion of the shaft is configured to extend completely through the aperture of the backing board. Furthermore, the knob backcover member is configured to securely fasten around the portion of the shaft.

### CROSS-REFERENCE TO RELATED APPLICATION

This application claims priority under 35 U.S.C. §119(e) to U.S. Provisional Patent Application No. 61/803,392 filed on Mar. 19, 2013. The above-identified provisional patent application is hereby incorporated by reference in its entirety.

### TECHNICAL FIELD

The present disclosure relates generally to children's toys, and more particularly, to a screwless knob assembly for children's toys.

### BACKGROUND

Toys and toy assemblies can include knobs or dials for children to turn and manipulate. Conventional knobs can be threaded or fastened, for example via one or more screws, through a panel of a toy assembly so that after a period of use, the screws can become worn enabling the knobs to loosen and even disengage from the toy assembly. If a knob (and/or its pieces) becomes loose, the knob can be lost, turn into a projectile (if thrown by a child) or may even rise to the level of a choking hazard. Furthermore, knobs fastened via screws through a panel can require machining or manufacturing steps. In addition, conventional knobs that are installed prior to packaging generally will cause the packaging to be larger, thus increasing packaging and shipping costs.

Accordingly, there is a need to provide safe toys and toy assemblies for children while reducing the manufacturing steps and packaging costs of such toys and toy assemblies.

Furthermore, conventional knobs are often attached to toy assemblies during manufacturing or assembly before the point of sale. Due to the structure of the conventional knobs and/or the structure of the toy assemblies, it may be difficult to attach the conventional knobs to the assemblies after the point of sale. Additionally, conventional knobs are often shipped in one piece. These conventional knobs can be damaged rendering them unusable during the assembly of the toy assemblies. As such, risks exist that these knobs could be damaged or knocked off the toy assemblies before the point of sale or use.

Accordingly, there is a need to provide knobs for toy assemblies that have a low risk of damage and can be easily attached to the toy assemblies by a user and/or purchaser after the point of sale.

### SUMMARY

According to an embodiment of the disclosure, there is provided a screwless knob assembly including a knob member and a knob backcover member. The knob member includes a handle and a shaft. The shaft is disposed opposite the handle and is configured to communicate through an aperture of a backing board. A portion of the shaft is configured to extend completely through the aperture of the backing board. Furthermore, the knob backcover member is configured to securely fasten around the portion of the shaft.

According to an embodiment of the disclosure, there is provided a method of assembling a screwless knob assembling. The method includes communicating a shaft of a knob member through an aperture of a backing board. The shaft is communicated until a portion of the shaft extends completely through the aperture and until a handle of the knob member, disposed opposite from the shaft, engages with a surface of the backing board. The method further includes securely fastening a knob backcover member around the portion of the shaft.

The foregoing has outlined rather broadly the features and technical advantages of the present disclosure so that those skilled in the art may better understand the detailed description that follows. Additional features and advantages of the present disclosure will be described hereinafter that form the subject of the claims. Those skilled in the art should appreciate that they may readily use the concept and the specific embodiment(s) disclosed as a basis for modifying or designing other structures for carrying out the same or similar purposes of the present disclosure. Those skilled in the art should also realize that such equivalent constructions do not depart from the spirit and scope of the claimed invention in its broadest form.

Before undertaking the Detailed Description below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an exploded view of a screwless knob assembly in accordance with an embodiment of the present disclosure;

FIG. 2A illustrates a cross-sectional view of an example screwless knob assembly in accordance with an embodiment of the present disclosure;

FIGS. 2B and 2C illustrate examples of a knob backcover member in accordance with an embodiment of the present disclosure;

FIG. 3 illustrates an exploded view of a screwless knob assembly in accordance with an embodiment of the present disclosure;

FIGS. 4 and 5 illustrate examples of a knob member in accordance with an embodiment of the present disclosure;

FIGS. 6 through 10 illustrate examples of a screwless knob assembly in accordance with embodiments of the present disclosure;

FIGS. 11A and 11B illustrate examples of a backing board in accordance with embodiments of the present disclosure;

FIGS. 12 and 13 illustrate example toy assemblies including a screwless knob assembly in accordance with embodiments of the present disclosure; and

FIG. 14 illustrates an example method of assembling a screwless knob assembly in accordance with embodiments of the present disclosure.

### DETAILED DESCRIPTION

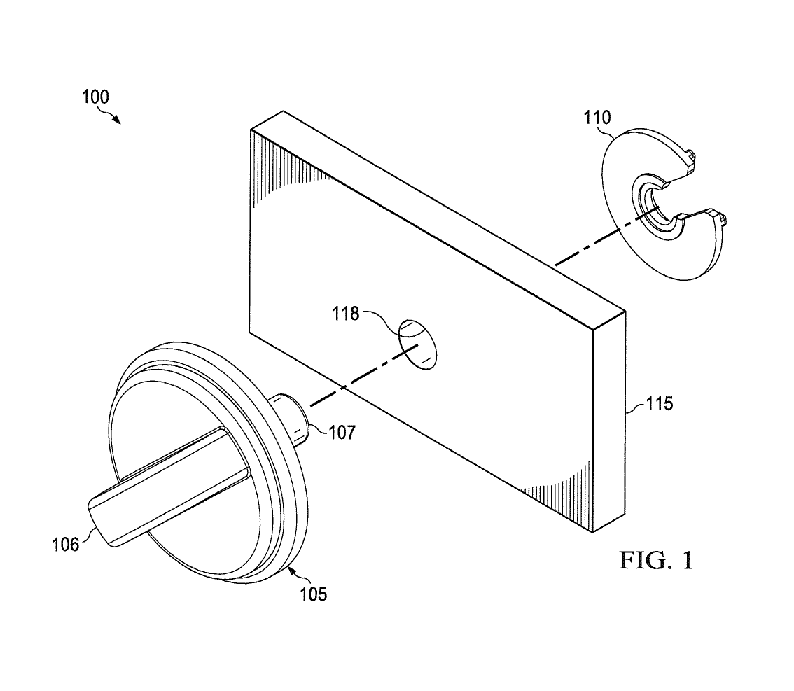

FIGS. 1-14 and the various embodiments used to describe the principles of the present disclosure in this patent document are by way of illustration only and should not be construed in any way to limit its scope. Those skilled in the art will understand that the principles described herein may be implemented with any type of suitably arranged device and/or devices.

To simplify the drawings, reference numerals from previous drawings may sometimes not be repeated for structures that have already been identified.

Referring to FIG. 1, there is illustrated an exploded view of a screwless knob assembly 100 in accordance with an embodiment of the present disclosure. The screwless knob assembly 100 includes a knob member 105, a knob backcover member 110, and a backing board 115 (e.g., a front panel). The knob member 105 includes a handle 106 and a shaft 107. The handle 106 can be positioned at one end of the knob member 105 while the shaft 107 can be positioned at an end opposite the knob member 105 from the handle 106. The handle 106 is configured for gripping the knob member 105, for example in order to turn, push, or the pull the knob member 105, by a hand, a tool, or the like.

The knob 105 and/or the handle 106 includes a radial cross-section with a diameter (or minimum cross-sectional distance) larger than a diameter (or maximum cross-sectional distance) of an aperture 118 disposed through the backing board 115. For example, as will be discussed further herein, the knob 105/handle 106 is configured to engage with a first surface (e.g., surrounding an entrance to or opening of the aperture 118) of the backing board 115 after the shaft 107 is inserted or communicated through the aperture 118.

The shaft 107 of the knob member 105 is configured to be inserted through the aperture 118 of the backing board 115 to provide a cross-sectional configuration for extending through the aperture 118 as well as for rotating within the aperture 118. For example, both the aperture 118 and the shaft 107 can include circular cross-sections with uniform diameters along their respective axes so that the shaft 107 can communicate through and rotate within the aperture 118. Accordingly, the diameter (or maximum cross-sectional distance) of the shaft 107 can include a distance less than a diameter (or minimum cross-section distance) of the aperture 118.

In one embodiment, while the diameter of the shaft 107 can include a distance less than a diameter of the aperture 118, the difference between the diameter of the shaft 107 and the diameter of the aperture 118 can be configured such that a shaft 107 positioned within the aperture 118 has an axis substantially parallel with the axis of the aperture 118. For example, after the shaft 107 has been communicated through the aperture 118 so that the handle 106 can engage the first surface of the backing board 115, the difference between the diameter of the shaft 107 and the diameter of the aperture 118 can allow for the axis of the shaft 107 to be substantially parallel with the axis of the aperture 118.

In an embodiment, the shaft 107 has a length such that the distance between the handle 106 and the distal end of the shaft 107 is greater than the depth of the aperture 118. For example, an axial portion of the shaft 107 can be communicated completely through the aperture 118 and extended beyond a second surface (e.g., surrounding an exit from or opening of the aperture 118 and opposite the first surface) of the backing board 115 before the handle 106 engages the first surface of the backing board 115 preventing further communication of the shaft 107 through the aperture 118.

As previously disclosed, the screwless knob assembly 100 includes a knob backcover member 110. The knob backcover member 110 securely fastens around at least a portion of the shaft 107 which, when affixed to the backing board 115 (as described later), secures the knob member 105 to the board 115. In one embodiment, the knob backcover member 110 includes a ring, such as semi-circular ring, with an inner diameter capable of securely fastening around at least a portion of the circumference of the shaft 107 (or a recess disposed around the circumference of the shaft as will be disclosed further herein). For example, the ring may be constructed of an elastic material which can be manipulated (e.g. bent out of its natural shape) so that the inner diameter of the ring can be moved into a suitable position around at least a circumferential portion of the shaft 107. Subsequently, due to the elasticity of the ring, once the ring has been moved into the proper position on the shaft 107, the ring is able to snap back into its natural shape and securely fastens the knob backcover member 110 around at least a circumferential portion of the circumference of the shaft 107. The ring can also include an outer diameter which is greater than at least the diameter of the opening of the aperture 118 surrounded by the second surface of the backing board 115.

The knob backcover member 110 is coupled to the shaft 107, for example, at or near the distal end of the shaft 107. For example, after a portion of the shaft 107 has been communicated (inserted) through the aperture 118 extending beyond the second surface of the backing board 115 and the handle 106 has engaged the first surface of the backing board 115, the knob backcover member 110 is coupled with the portion of the shaft 107 extending beyond the second surface of the backing board 115.

As will be appreciated, the knob backcover member 110 implemented in conjunction with the handle 106 of the knob member 105 limits axial movement of the shaft 107 through the aperture 118, thereby securing the knob member 105 with the backing board 115 via the aperture 118. As such, the shaft 107 can be retained within the aperture 118 securing the knob member 105 in relation to the backing board 115.

Furthermore, the knob backcover member 110 implemented in conjunction with the handle 106 of the knob member 105 is configured to permit rotation (partial or complete rotation, generally unimpeded rotation) of the knob member 105 within the aperture 118 about the backing board 115 in a clockwise direction and/or a counterclockwise direction. This rotation occurs without loosening or disengaging the knob member 105 from the backing board 115. In one embodiment, the knob member 105 can be rotated 360 degrees in a clockwise direction and/or in a counterclockwise direction numerous times without loosening or disengaging the knob member 105 from the backing board 115.

It should be understood that “impeded rotation” can mean rotation that is halted or stopped by an obstruction such that in order to overcome the obstruction and continue rotation, the structural integrity of one or members would be compromised, for example by inelastic deformation of a member or a fracture of a member. Thus, “unimpeded rotation” can mean rotation that is not halted or stopped by an obstruction. As such, while frictional forces or bending moments that create elastic deformation on or between adjacent or engaging members may impeded or slow the rotation of a member, for the purposes of this disclosure, the presences of such frictional forces or bending moments can exist in conjunction with “unimpeded rotation.”

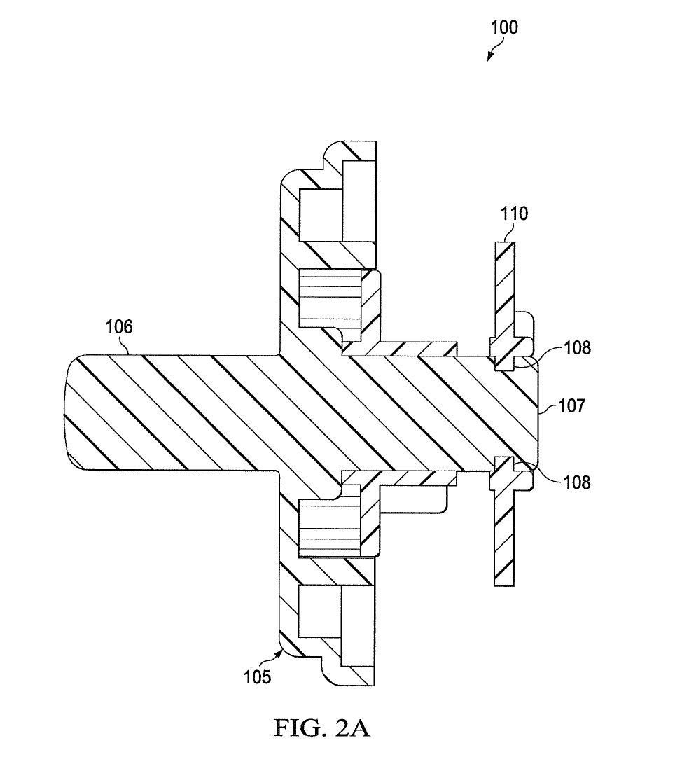

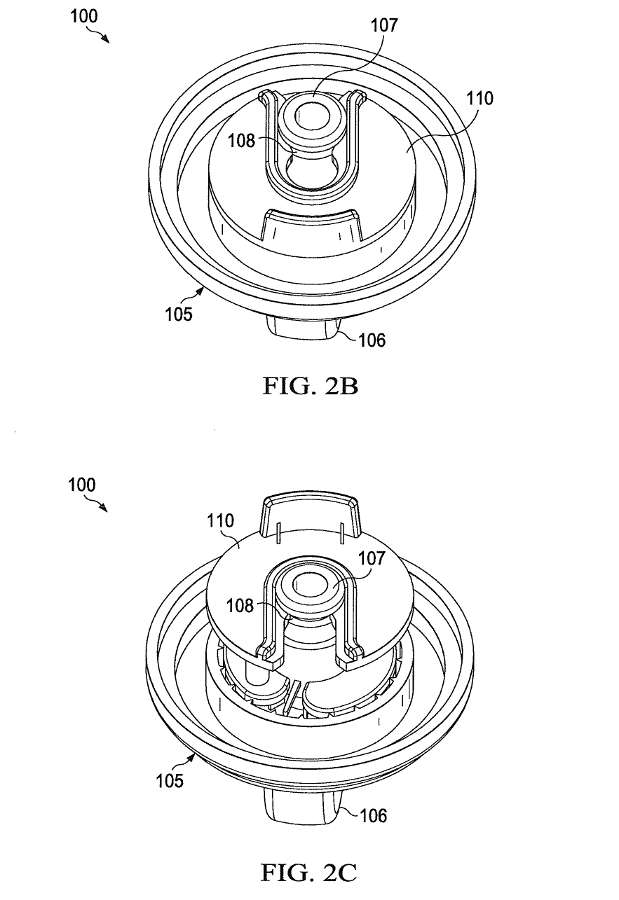

FIG. 2A illustrates a cross-sectional view of the knob member 105 and the knob backcover member 110 attached thereto (but without showing the backing board 115). Additionally shown is a recess or groove 108 disposed on the surface of the distal end of the shaft 107 and around its circumference (or at least partially around the circumference). As will be appreciated, the recess 108 portion of the shaft 107 will extend beyond the inner surface of the backing board 115 when the shaft 107 is inserted through the aperture 118.

The recess 108 is configured to engage a portion of the knob backcover member 110 and further maintain engagement between the shaft 107 and the knob backcover member 110. In an embodiment, the walls of the recess 108 are configured to at least limit axial movement of the knob backcover member 110 along the shaft 107. For example, the walls of the recess 108 can be configured to prevent the knob backcover member 110 from sliding off the distal end of the shaft 107 when the handle 106 is pulled away from the first surface of a backing board, such as backing board 115 illustrated in FIG. 1.

In an embodiment, the smaller shaft diameter created by the recess 108 can also at least assist in fastening the knob backcover member 110 around the shaft 107. For example, the ring can be composed of an elastic material which can be manipulated (e.g. bent out of its natural shape) so that the inner diameter of the ring can be moved into axial alignment with the recess 108. Subsequently, due to the elasticity of the ring, once the ring has been moved into axial alignment with the recess 108, the smaller shaft diameter created by the recess 108 can permit the ring to snap back into its natural shape and securely fastened the knob backcover member 110 around at least a portion of the circumference of the shaft 107.

FIGS. 2B and 2C illustrate two different configurations of the knob backcover member 110 in accordance with an embodiment of the present disclosure. Similar to FIG. 2A, FIGS. 2B and 2C illustrate the screwless knob assembly 100 including the knob member 105 and the knob backcover member 110. Furthermore, similar to FIG. 2A, the knob member 105 includes the handle 106, the shaft 107, and the recess 108.

FIG. 2B illustrates an example of a knob backcover member 110 before the knob backcover member 110 has elastically deformed to securely engage around the shaft 107 at the recess 108 (initial position as it is being engaged to full secured engagement). FIG. 2C illustrates an example of a knob backcover member 110 after the knob backcover member 110 has elastically deformed and returned to its original form while being securely engaged in the recess 108 of the shaft 107 (full secured position).

The knob backcover member 110 can include a receiving portion (a slot) configured to receive the shaft 107 (and its recess 108). The receiving portion of the member 110 includes a narrowing segment (e.g., two protrusions or tabs extending inward to narrow the width of the slot) configured to engage the shaft 107/recess 108 and elastically deform when engaging with the shaft 107/recess 108 (see FIG. 2B) with sufficient force. As the narrowing segment passes around the shaft 107/recess 108 and is released from engagement with the shaft 107/recess 108, the knob backcover member 110 returns to its original form and is securely fastened to the shaft 107 (see FIG. 2C). It will be understood that the dimension between the two tabs is less than the dimension of the shaft 107/recess 108.

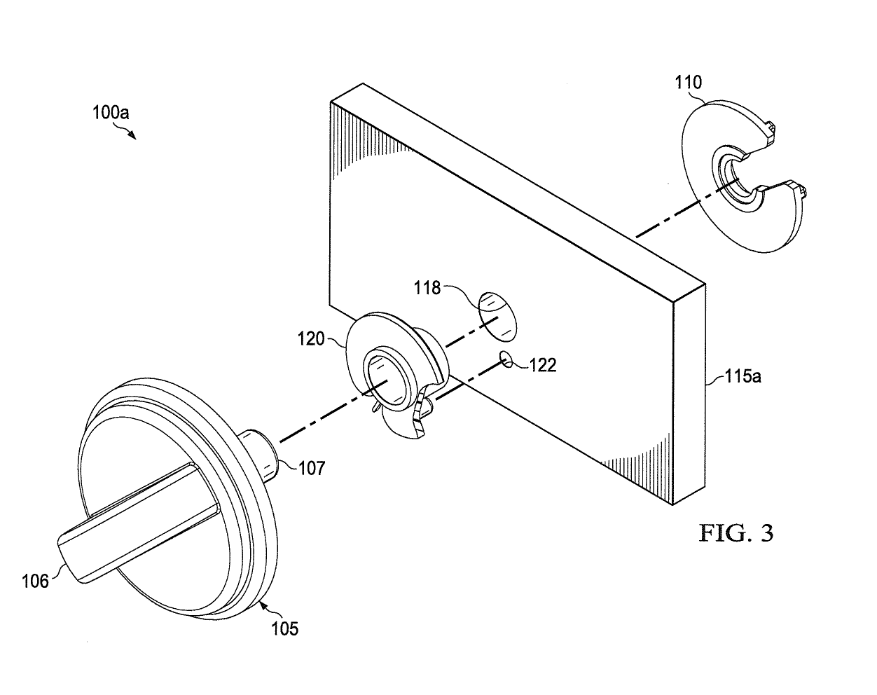

Referring to FIG. 3, there is illustrated an exploded view of a screwless knob assembly 100a in accordance with another embodiment of the present disclosure. Similar to the embodiment illustrated in FIG. 1, the screwless knob assembly 100a includes the knob member 105, the knob backcover member 110, and a backing board 115a. Also similar to the embodiment illustrated in FIG. 1, the knob member 105 include the handle 106 and the shaft 107. As illustrated in FIG. 3, the screwless knob assembly 100a includes an auditory (noise) generating member 120 (see also FIG. 6). The noise member 120 can be configured to generate any type of noise, such as a clicking noise, as the knob member 105 is rotated in a clockwise or counterclockwise direction while the knob member 105 is secured to the backing board 115a. A guide hole or aperture 122 is disposed in the board 115a to receive a corresponding coupling member 155 that fixes the noise member 120 in relation to the backing board 115a.

Now turning to FIG. 4, there is illustrated a perspective view of one example of the knob member 105 in accordance with one embodiment of the present disclosure. The knob member 105 is shown with the handle 106, the shaft 107 and the recess 108. As illustrated in FIG. 4, the knob member 105 further includes a seat 170 and multiple notches or tabs 175 disposed and spaced around the wall of the seat 170. The tabs 175 extend radially inward towards to the center axis of the shaft 107. The seat 170, the tabs 175 and the shaft 107 are configured to correspond with the noise member 120 to generate noise as the knob member 105 is turned clockwise or counterclockwise. The depth of the seat 170 is chosen to permit the noise member 120 to rest on the seat 170 so that a tab engaging member (to be discussed further herein) is radially aligned with and capable of engaging the one or more tabs 175.

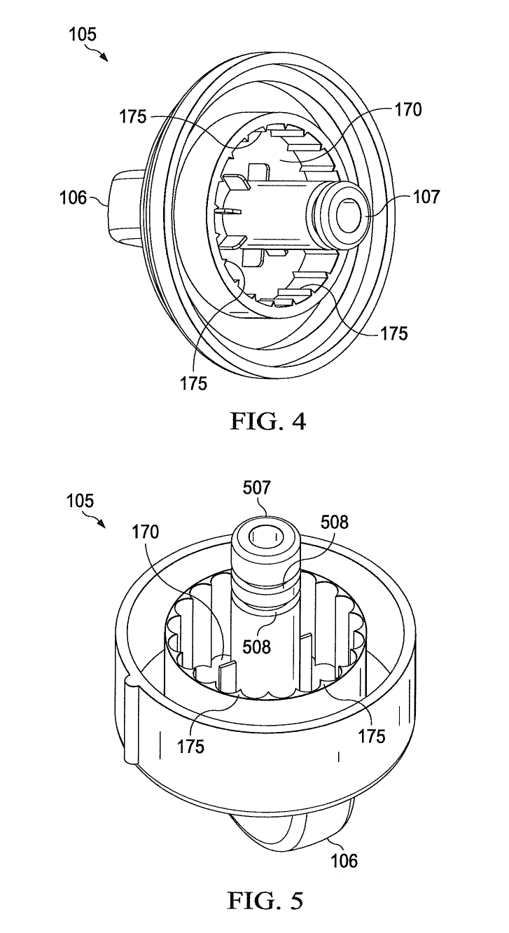

Now turning to FIG. 5, there is shown a perspective view of one example of a knob member 105a in accordance with a different embodiment of the present disclosure. Similar to the embodiment shown in FIG. 4, the knob member 105a includes the handle 106, a shaft 507, the seat 170, and the multiple notches or tabs 175. In this embodiment, the knob member 105 includes a plurality of recesses 508. Each of the plurality of recesses 508 can be longitudinally disposed along the shaft 507. As such, the screwless knob assembly 100 can be configured to adjust to the thickness of a backing board 115 or 115a by fastening the knob backcover member 110 to a select one of the plurality of recesses 508 in order to accommodate a different thickness of the backing board 115 or 115a. In addition, in this embodiment, the recesses 508 do not necessarily extend circumferentially and entirely (e.g., 360 degrees) around the shaft 507. Instead at each longitudinal position, two diametrically opposed recesses 508a, 508b are disposed in the shaft 507, with each recess extending less than about 180 degrees therearound.

FIG. 6 illustrates the knob member 105 (shown in FIG. 4) including the noise member 120. Additionally, similar to previous embodiments, the screwless knob assembly 100 can also include a knob noise member 120.

As shown, the noise member 120 includes a tab or notch engaging member 150, the backing board coupling member 155, a shaft coupling member 160, and a handle engaging member 165. The shaft coupling member 160 is configured to be inserted over the distal end of the shaft 107 and slid along the shaft until the handle engaging member 165 engages a seat of the knob member 105. The shaft coupling member 160 is further configured to permit the unimpeded rotation of the shaft 107 and thus the knob member 105.

The notch/tab engaging member 150 is positioned in circumferential alignment with the handle engaging member 165 along the center axis of the shaft coupling member 160. Furthermore, for reasons to be disclosed further herein, the tab engaging member 150 may extend a distance further than the handle engaging member 165 in a radial direction from the center axis of the shaft coupling member 160.

The backing board coupling member 155 can extend from a surface of the handle engaging member 165 in a direction parallel with the center axis of the shaft coupling member 160. The backing board coupling member 165 is configured for reception into the guide hole or aperture 122 disposed within the backing board 115a (illustrated in FIG. 3). The backing board coupling member 165, when received within the aperture 122 while the shaft coupling member 160 is coupled to the shaft 107 and while the handle engaging member 165 is position on the seat 107, functions to enable the noise member 120 to remain static (e.g., no rotation) when the knob member 105 is rotated in the clockwise or counterclockwise direction as previously discussed herein. Thus, the noise member is fixed relative to the backing board 115a, and when the knob 105 is turn, the notches/tabs 175 and tab/notch engaging member 150 function to generate noise (e.g., clicking noise).

As illustrated in FIG. 6, the knob noise member 120 is resting on the seat 170 of the knob member 105 such that the shaft coupling member 160 is coupled to the shaft 107 and the handle engaging member 165 and the notch engaging member 150 are radially aligned with the tabs or notches 175. The outer diameter of the handle engaging member 165 includes a distance so that when the noise member 120 is resting on the seat of the handle 106/knob member 105, the handle engaging member 165 is unable to engage the tabs or notches 175. Conversely, the tab or notch engaging member 150 can extended a radial distance beyond the radial reach of the handle engaging member 165 so that when the noise member 120 is resting on the seat of the handle 106/knob member 105, the handle engaging member 165 can engage the tabs/notches 175.

In operation, when the screwless knob assembly 100 is assembled such that shaft 107 is communicated through the aperture 118 of the backing board 115a securing the knob member 105 (or 105a) to the backing board 115a in conjunction with the knob backcover member 110 while the noise member 120 is engaged with the seat of the handle 106/knob member 105 and the backing board coupling member 155 is coupled with the guide hole or aperture 122, the handle 106 can be gripped and the knob member 105 can be turned in a clockwise or counterclockwise direction. Because the backing board coupling member 155 is coupled with the aperture 122, the noise member 120 is unable to rotate with the knob member 105. As such, as the knob member 105 is rotated, the tabs/notches 175 can engage with the notch/tab engaging member 150, elastically deforming the notch engaging member 150. After the knob member 105 is rotated further so that notch engaging member 150 is released from engagement with a notch 175, the notch/tab engaging member 150 “snaps” back to its original form thereby generated a snapping or clicking sound. Accordingly, when the tabs/notches 175 are disposed around the wall formed by the seat and the knob member 105 is rotated either in a clockwise or counterclockwise direction, a snapping or clicking sound can be generated when the notch engaging member 150 is release from engagement with one of the tabs/notches 175.

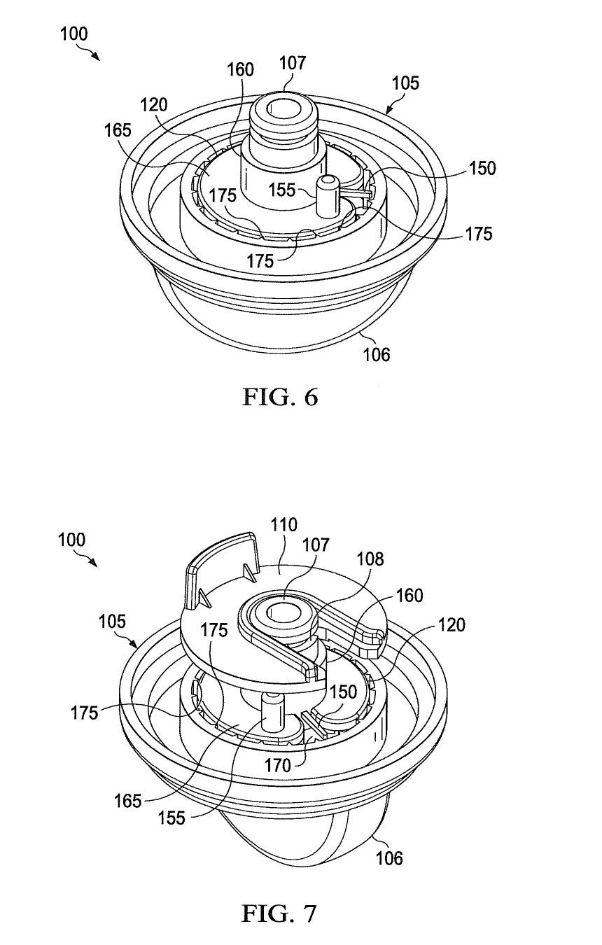

FIG. 7 is a perspective view illustrating the complete entire assembled screwless knob assembly 100, 100a (shown not installed to the backing board 115, 115a) in accordance with embodiments of the present disclosure. This assembly 100, 100a is shown with the optional noise member 150.

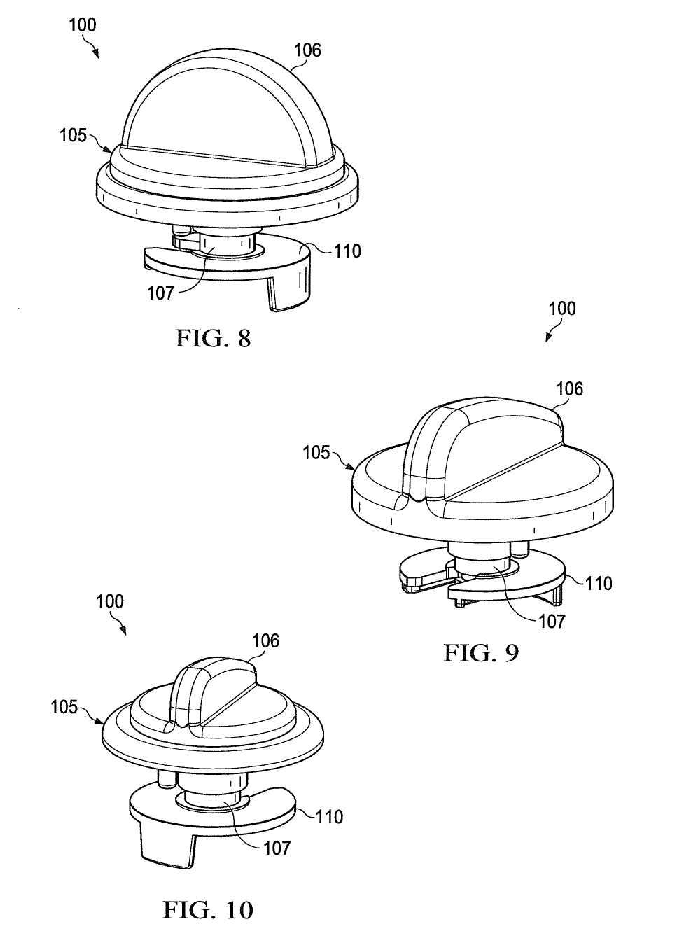

FIGS. 8 through 10 illustrates various configurations or shapes of the knob member 105, 105a that can be used with the screwless knob assembly 100, 100a in accordance with embodiments of the present disclosure. For example, and in specific embodiments, the screwless knob assembly 100 can have a handle 106 with a diameter of 56.7 mm, 45 mm, or 36 mm and a height of 32.3 mm, 22.7 mm, or 16.9 mm, respectively. Furthermore, in an embodiment, the handle 106 can have a thickness of 10 mm while the distance between the handle 106 and the knob backcover member 110 secured to the shaft 107 can be 12 mm. Additionally, in a specific embodiment, the shaft 107 can have a diameter of 12 mm.

In an embodiment, a distance from the top of the handle 106 to the bottom of the knob backcover member 110 secured to the shaft 107 can be 43.5 mm or 37.5 mm while a distance between the handle 106 and the knob backcover member 110 secured to the shaft 107 can be 12 mm.

In an embodiment, the handle 106 can have an outer diameter of 55 mm and an inner diameter of 36 mm. Additionally, the handle 106 can have a first portion with a thickness of 6 mm and second portion with a thickness of 6.3 mm.

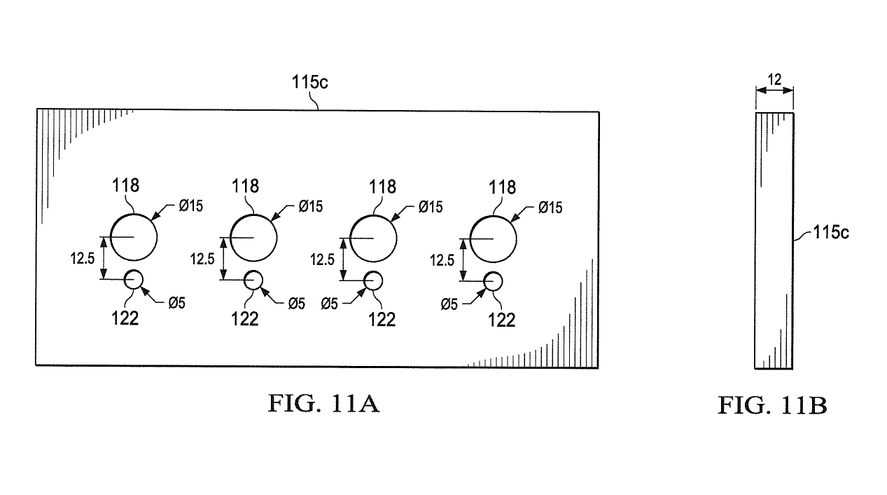

FIGS. 11A and 11B illustrate examples of a backing board 115c in accordance with embodiments of the present disclosure. The backing board 115c can include one or more apertures 118 each paired with a knob noise notch aperture 122. As such a plurality of knob members 105 can be secured to a single backing board, such as backing board 115c through a plurality of apertures 118 paired with knob noise notch apertures 122. Furthermore, FIG. 11A illustrates a specific embodiment of a backing board 115c such that each of the apertures 118 can have a diameter of 15 mm while each of the knob noise notch apertures 122 can have a diameter of 5 mm. Additionally, FIG. 11A illustrates a specific embodiment of a backing board 115 such that the distance between the center axis of an aperture 118 and the center axis of the aperture 118's paired knob noise notch aperture 122 can have a distance of 12.5 mm. FIG. 11B illustrates a specific embodiment of a backing board 115c such that the thickness of the backing board 115c can be 12 mm.

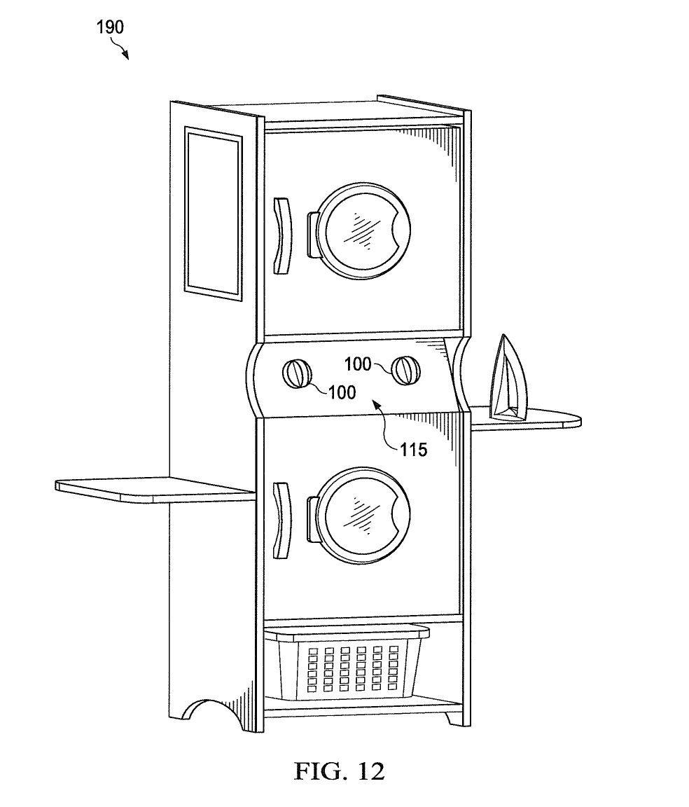

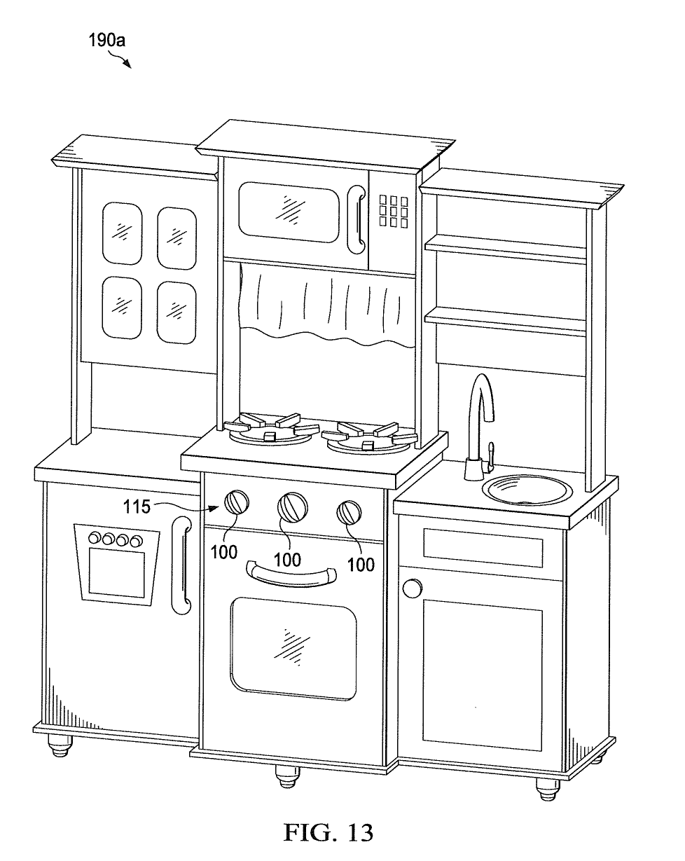

FIG. 12 illustrates an example toy assembly 190 including a screwless knob assembly 100 in accordance with embodiments of the present disclosure. Screwless knob assembly 100 is similar to previous embodiments of screwless knob assemblies disclosed herein. As illustrated in FIG. 12, the backing board 115 or 115a can be integrated as a panel of the toy assembly 190. Similarly, FIG. 13 illustrates an example toy assembly 190 including a screwless knob assembly 100 in accordance with embodiments of the present disclosure. Screwless knob assembly 100 is similar to previous embodiments of screwless knob assemblies disclosed herein. As illustrated in FIG. 13, the backing board 115 or 115a can be integrated as a panel of the toy assembly 190.

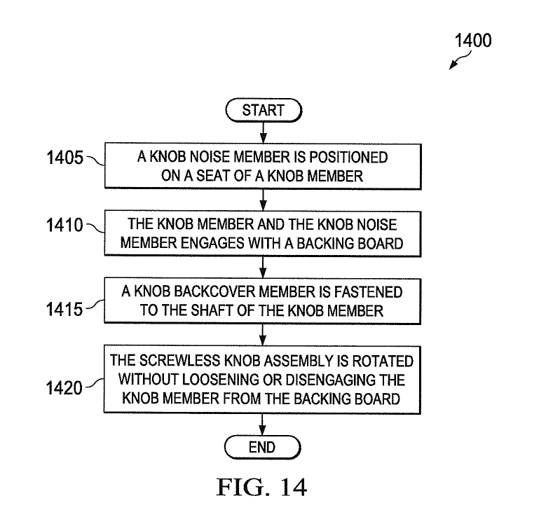

FIG. 14 illustrates an example method 1400 of assembling a screwless knob assembly 100 in accordance with embodiments of the present disclosure. At step 1405, the knob noise member 120 can be positioned on a seat 170 of a knob member 105. For example, a shaft coupling member 160 of the knob noise member 120 can be inserted over the shaft 107 and slid along the shaft 107 until the knob noise member 120 engages the seat 170. Additionally, when the knob noise member 120 engages the seat 170, the notch engaging member 150 and the handle engaging member 165 can be radially aligned with the one or more notches 175.

At step 1410, the knob member 105 and the knob noise member 120 can engage with the backing board 115 or 115a. For example, the shaft 107 can be axially aligned with the aperture 118 of the backing board 115 or 115a and the backing board coupling member 155 can be axially aligned with the knob noise notch aperture 122 of the backing board 115 paired with the aperture 118.

Furthermore, the shaft 107 can be communicated into and through the aperture 118 while the backing board coupling member 155 can be communicated at least into the knob noise notch aperture 122 until the handle 106 engages with the first surface of the backing board 115 surrounding an opening to the aperture 318 and the knob noise notch aperture 122. Additionally, the shaft 107 can be communicated through the aperture 118 and out another opening of the aperture 118 surrounded by a second surface of the backing board 115 or 115a opposite the first surface before the handle 106 engages with the first surface of the backing board 115 or 115a. As such, a portion of the shaft 107 at the distal end of the shaft 107 can extended completely through the aperture 118 and beyond the second surface of the backing board 115 or 115a.

At step 1415, the knob backcover member 110 can be fastened to the shaft 107 of the knob member 105 opposite the handle 106 securely retaining the knob member 105 with the backing board 115 or 115a. For example, after the shaft 107 has been extended through the aperture 118 so that a portion of the shaft 107 at the distal end can extend beyond the second surface of the backing board 115 or 115a and the handle 106 engages the first surface of the backing board 115 or 115a, the knob backcover member 110 can be fastened around or snapped around the extended portion of the shaft 107. In an embodiment, the knob backcover member 110 can be fastened into a recess 108 disposed around the circumference of the extended portion of the shaft 107. Furthermore, the shaft 107 can include a plurality of recess 108 disposed longitudinally along the shaft 107. As such, the knob backcover member 110 can be fastened with any one of the plurality of recess 108 in order to accommodate a thickness of the backing board 115 or 115a.

At step 1420, the screwless knob assembly 100 can be rotated in a clockwise direction or a counterclockwise direction without loosening or disengaging the knob member 105 from the backing board 115 or 115a and without impeding the rotation, for example by an obstruction. In an embodiment, the screwless knob assembly 100 can be rotated in order to generate a snapping or clicking sound. For example, as previously disclosed herein, because the backing board coupling member 155 is coupled to the backing board 115 or 115a via the knob noise notch aperture 122, as the knob member 105 is rotated, the knob noise member 120 can be held from rotation with the knob member 105. Furthermore, as the knob member 105 is rotated, the notch engaging member 150 can engage with and snap or click over each of the one or more notches disposed around the interior wall formed by the seat 170.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An assembly comprising:
a knob member comprising:
a handle, and
a shaft disposed opposite the handle and configured to communicate through an aperture of a backing board, wherein a portion of the shaft is configured to extend completely through the aperture of the backing board; and
a knob backcover member configured to securely fasten around the portion of the shaft.

2. The assembly of claim 1, wherein the assembly is configured to permit unimpeded rotation when the knob member is coupled to the backing board.

3. The assembly of claim 2, wherein the unimpeded rotation comprises a clockwise rotation and a counterclockwise rotation.

4. The assembly of claim 1, wherein the assembly is configured to rotate in a clockwise direction and a counterclockwise direction when the knob member is coupled to the backing board without loosening or disengaging the knob member from the backing board.

5. The assembly of claim 1, further comprising a knob noise member configured to generate a noise when the shaft is rotated in the aperture of the backing board.

6. The assembly of claim 5, wherein the handle comprises one or more notches and the knob noise member comprises a notch engaging member, wherein the one or more notches are configured to engage and subsequent disengage with the notch engaging member in order to generate the noise.

7. The assembly of claim 6, wherein the knob noise member is configured to abstain from rotating when the shaft is rotated in the aperture of the backing board so that the one or more notches engage and rotationally pass by the notch engaging member in order to generate the noise.

8. The assembly of claim 1, wherein the portion of the shaft comprises a recess configured to securely fasten the knob backcover member to the portion of the shaft.

9. The assembly of claim 1, wherein the portion of the shaft comprises a plurality of recesses disposed longitudinally along the portion of the shaft and wherein each of the plurality or recesses are disposed around at least a part of the circumference of the portion of the shaft.

10. The assembly of claim 1, wherein the backing board is a panel of a toy assembly.

11. A method of assembling a screwless knob assembly, the method comprising:
communicating a shaft of a knob member through an aperture of a backing board until a portion of the shaft extends completely through the aperture and until a handle of the knob member, disposed opposite from the shaft, engages with a surface of the backing board; and
securely fastening a knob backcover member around the portion of the shaft.

12. The method of claim 11, further comprising disposing a knob noise member over the shaft, sliding the knob noise member along the shaft, and engaging the knob noise member with a seat of the knob member.

13. The method of claim 12, wherein engaging the knob noise member with the seat of the knob member comprises radially aligning a notch engaging member of the knob noise member with one or more notches disposed with the handle.

14. The method of claim 11, wherein securely fastening the knob backcover member around the portion of the shaft comprise fastening the knob backcover member into a recess circumferentially disposed around the portion of the shaft.

15. The method of claim 11, wherein securely fastening the knob backcover member around the portion of the shaft comprises selecting one of a plurality of recesses longitudinally disposed around the portion of the shaft in order to accommodate a thickness of the backing board.

16. The method of claim 11, further comprising rotating the shaft within the aperture without loosening or disengaging the knob member from the backing board.

17. The method of claim 16, wherein rotating the shaft comprises unimpeded rotation in at least one of a clockwise direction or a counterclockwise direction.

18. The method of claim 12, further comprising rotating the shaft within the aperture and generating a noise.

19. The method of claim 18, wherein generating the noise comprises engaging and subsequently disengaging one or more notches disposed on a wall formed by a seat of the knob member with a notch engaging member of the knob noise member.

20. The method of claim 12, further comprising preventing the knob noise member from rotating when the shaft is rotated in the aperture in order to generate a noise.
